(19) United States
(12) Patent Application Publication
(10) Pub. No.: US 2005/0226590 A1
(43) Pub. Date: Oct. 13, 2005

(54) Variable optical attenuator based on rare earth doped glass

(76) Inventors: Falgun D. Patel, Pacifica, CA (US); Jeffrey N. Miller, Los Altos Hills, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/819,812

(22) Filed: Apr. 7, 2004

(51) Int. Cl. G02B 6/00; G02B 6/26; G02B 6/42

(52) U.S. Cl. 385/142; 385/141; 385/31

(57) ABSTRACT

A variable optical attenuator including a loss element and a rare earth doped gain element in optical communication with the loss element, the rare earth doped gain element having a gain responsive to an optical pump.

### FIELD OF THE INVENTION

The technical field of this disclosure is optical components, particularly variable optical attenuators in rare earth doped glass.

### BACKGROUND OF THE INVENTION

Variable optical attenuators are used in optical systems for various functions, such as signal equalization. Wavelength division multiplexed telecommunication systems are able to transmit signals without regeneration for longer distances if the intensity levels of the signals at all the wavelengths are equal. When signals are added at a node of the telecommunication system, the signals may have too high an intensity and a variable optical attenuator can be used to equalize the signals.

Variable optical attenuators can also be used for signal equalization when several different optical amplifiers provide respective optical signals with unique wavelengths to the optical fiber of a telecommunication system. The variable optical attenuators adjust the intensity of the optical signals to a uniform level. This allows the telecommunication system to include a greater number of amplifiers before optical regeneration is required.

Another use of variable optical attenuators is to limit the intensity when several different optical amplifiers provide respective optical signals with unique wavelengths to a telecommunication system fiber. Non-linear effects, such as non-linear scattering interactions or Brillioun scattering, occur if the intensity within the optical fiber is too great. The non-linear effects cause some of the signal to be frequency shifted or to propagate in the opposite direction. Phase matched parametric interactions may also occur at very high intensities, adversely affecting the bit error rate of the telecommunication system.

One type of existing variable optical attenuator includes movable micro-mirrors to change the coupling efficiency of a signal entering a telecommunication system. These micro-mirrors may become stuck in an on or off position so that the signal is permanently blocked or coupled. Material fatigue after extended use also causes failure of moving parts used in variable optical attenuators. The properties of a material forming a micro-electro-mechanical system (MEMS) hinge, for example, may change after hundreds of rotations degrading the range of motion available from the hinge.

Another type of existing variable optical attenuator uses thermo-optic properties attenuate a signal. A waveguide core is heated locally to change the index of refraction of the core. The propagating mode of the signal leaks into the cladding in the heated core region due to the change in the index of refraction of the core relative to the index of refraction of the cladding. The attenuation is a function of the heat applied. The usefulness of thermo-optic variable optical attenuator is limited by the high power required to heat the waveguide core and slow response time due to the thermal time constant of the waveguide core.

It would be desirable to have a variable optical attenuator that would overcome the above disadvantages.

### SUMMARY OF THE INVENTION

The present invention is a variable optical attenuator with no moving parts and no heating required. A loss element and a rare earth doped gain element are optically connected to form the variable optical attenuator. The attenuation of a signal transmitted through the variable optical attenuator is a function of the intensity of pump power coupled to a rare earth doped gain element.

One aspect of the present invention provides a variable optical attenuator including a loss element, and a rare earth doped gain element in optical communication with the loss element, the rare earth doped gain element having a gain responsive to an optical pump.

A second aspect of the present invention provides a method of varying optical attenuation. A loss element and a rare earth doped gain element are optically connected in series. An optical signal is passed through the loss element and the gain element. The optical signal is attenuated in the loss element. The gain element is illuminated with optical pump power having an intensity that defines the attenuation.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 shows a schematic of a variable optical attenuator in accordance with the present invention;

FIG. 2 shows the optical intensity of a signal passing through an exemplary variable optical attenuator for various levels of attenuation;

FIG. 3 shows a schematic of the loss element;

FIG. 4 shows a schematic of the gain element;

FIG. 5 shows an energy level diagram for a three level system for an exemplary erbium ion Er³⁺;

FIG. 6 shows measured and theoretical gain spectra for a gain element made in accordance with the present invention;

FIG. 7 shows an absorption curve for a loss element in accordance with the present invention;

FIG. 8 shows a schematic of a variable optical attenuator in accordance with the present invention operating in reverse mode;

FIG. 9 shows a schematic of a second embodiment of a variable optical attenuator in accordance with the present invention; and

FIG. 10 shows a schematic of a third embodiment of a variable optical attenuator in accordance with the present invention.

### DETAILED DESCRIPTION OF PRESENTLY PREFERRED EMBODIMENTS

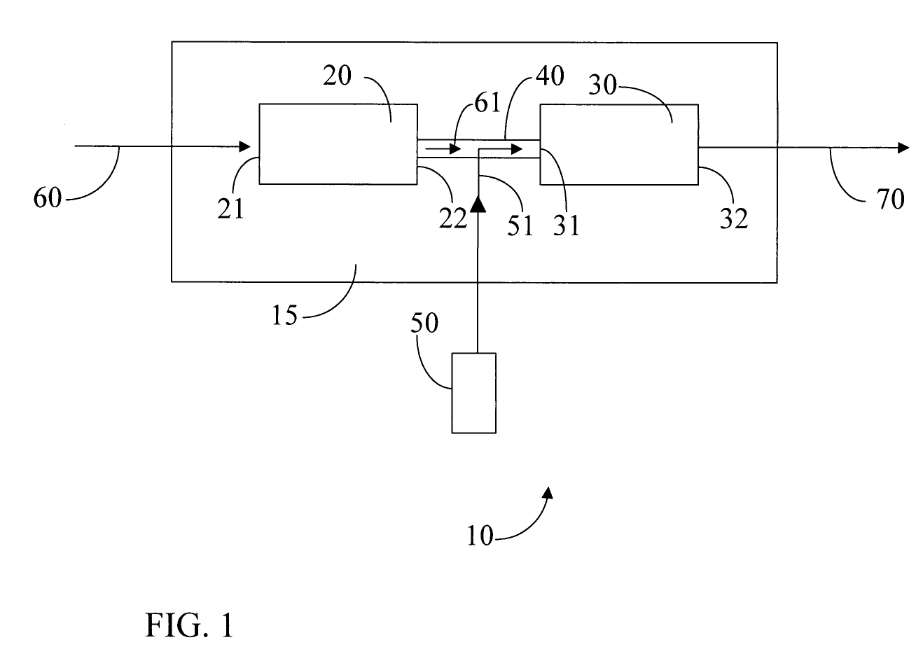

FIG. 1 shows a schematic top view of a variable optical attenuator 10, which is composed of a loss element 20 and a gain element 30 both on a supporting substrate 15 and an optical pump source 50. In an alternative embodiment the optical pump source 50 may also be an edge emitting diode laser on the substrate 15. The loss element 20 has an input endface 21 and an output endface 22 and transmits a portion of the input optical signal 60 coupled to the input endface 21. Output endface 22 is optically coupled to coupling device 40, which transmits attenuated optical signal 61. The gain element 30 has an input endface 31 and an output endface 32. The coupling device 40 couples attenuated optical signal 61 to the input endface 31 of the gain element 30. The coupling device 40 optically couples a loss element to a rare earth doped gain element.

Optical pump source 50 emits an optical pump 51, which is coupled to the gain element 30. The intensity of the optical pump 51 illuminating the gain element 30 is varied to control the attenuation of variable optical attenuator 10.

The output optical signal 70 is output from the gain element 30 at output endface 32. The intensity of the output optical signal 70 emitted from the gain element 30 is a function of the intensity of the optical pump 51 illuminating the gain element 30. The coupled optical pump 51 amplifies the attenuated optical signal 61 as it propagates through the gain element 30. The amplification depends upon the intensity of optical pump 51 co-propagating through the gain element 30 with attenuated optical signal 61.

If the absolute value of the loss in loss element 20 equals the gain provided by gain element 30, the output optical signal 70 will have the same optical intensity as the input optical signal 60. Alternatively, if the gain provided by gain element 30 is greater than the absolute value of loss in the loss element 40, the output optical signal 70 will be greater than the input optical signal 60. The maximum optical pump 51 is defined as the intensity of optical pump 51 that maximizes the gain provided by the gain element 30.

The intensity of optical pump 51 illuminating the gain element 30 is controlled by changing the intensity of optical pump 51 emitted by the optical pump source 50 or by changing the coupling between the optical pump source 50 and the gain element 30. The intensity of output optical signal 70 will vary between 0 dB relative to that of the input optical signal 60 to more than −60 dB relative to that of the input optical power 60, depending on the design of the variable optical attenuator and the intensity range of the optical pump 51 illuminating the gain element 30.

Coupling mechanisms by which the input optical signal 60 is coupled to the loss element 20 and by which the coupling element 40 optically communicates with the loss element 20 and the gain element 30 include lens coupling, end fire coupling, diffractive coupling, grating couplers, fused optical fiber couplers, and combinations thereof. The coupling mechanisms by which the coupling device 40 optically communicates with the loss element 20 and the gain element 30 include lens coupling, end fire coupling, diffractive coupling, and combinations thereof. The coupling mechanism by which the optical pump 51 is coupled to the gain element 30 includes diffractive couplers, y-branch couplers, directional couplers, grating couplers, fused optical fiber couplers, and combinations thereof. The coupling device 40 may be an optical fiber or an optical waveguide. In one embodiment, the coupling device 40 is omitted, and the gain element 30 and the loss element 20 are directly coupled by end fire coupling, lens coupling, or a combination thereof.

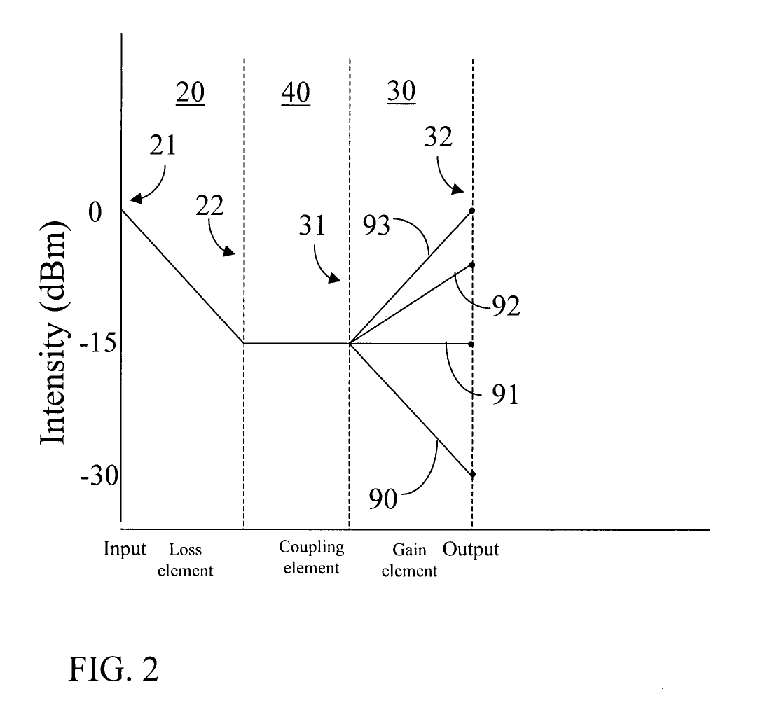

FIG. 2 shows the optical intensity of a signal passing through an exemplary variable optical attenuator 10 at various setting of the attenuation. In this exemplary embodiment, the maximum gain of the gain element 30 is equal to the loss through the loss element 20. In this example, the loss element 20 is configured to produce a loss of 15 dB and the gain element 30 is configured to produce a maximum gain of 15 dB when optical pump 51 is coupled to the gain element 30. Gain element 30 is configured to produce a loss of 15 dB when no optical pump 51 is coupled to gain element 30. In this example, at the input endface 21 of loss element 20, the intensity of the input optical signal 60 is 1 mW or 0 dBm. After propagating through the loss element 20, the input optical signal 60 is attenuated by 15 dB and has an optical intensity of −15 dBm or about 30 μW. The attenuated optical signal 61 is emitted from the output endface 22 of loss element 20. The attenuated optical signal 61 propagates without appreciable loss or gain through the coupling element 40 to the input endface 31 of the gain element 30.

The attenuated optical signal 61 then propagates through the gain element 30. The gain element 30 attenuates or amplifies attenuated optical signal 61 depending on whether optical pump 51 illuminates the gain element 30. The gain element 30 further attenuates attenuated optical signal 61 when no optical pump 51 is coupled to the gain element 30. Line 90 shows how the propagating signal is attenuated to 1 μW or −30 dB when pump source 50 is off or not coupled to the gain element 30.

The gain element 30 amplifies attenuated optical signal 61 when optical pump 51 is coupled to gain element 30, with amplification depending on the intensity of the optical pump 51. Lines 91 through 93 show how the intensity of the output optical signal varies depending on the intensity of the optical pump 51 illuminating the gain element 30. When the optical pump 51 illuminating gain element 30 has the intensity required to produce a gain that offsets the natural loss (line 90) of gain element 30, output optical signal 70 will have an intensity of about 30 μW or −15 dBm as indicated by line 91. Line 92 shows the intensity of the optical signal as it propagates through the gain element 30 when the optical pump 51 illuminating gain element 30 is high enough to produce a gain greater than that which offsets the natural loss but less than the maximum possible gain of 15 dB. In this case, output optical signal 70 will have an intensity of about 180 μW or about −7 dBm. Line 93 shows the intensity of the signal as it propagates through the gain element 30 when the optical intensity of pump 51 illuminating gain element 30 is high enough to produce the maximum possible gain of 15 dB. In that case, output optical signal 70 will have an intensity of about 1 mW or about 0 dBm, equal to that of the input optical signal 60.

The variable optical attenuator 10 is operable to produce various attenuations depending upon the intensity of the optical pump 51. In another embodiment, the maximum gain of the gain element 30 is selected so that the variable optical attenuator 10 provides an overall gain, i.e., the output optical signal 70 is greater in intensity than the input optical signal 60. The variable optical attenuator then acts as a variable attenuator or amplifier.

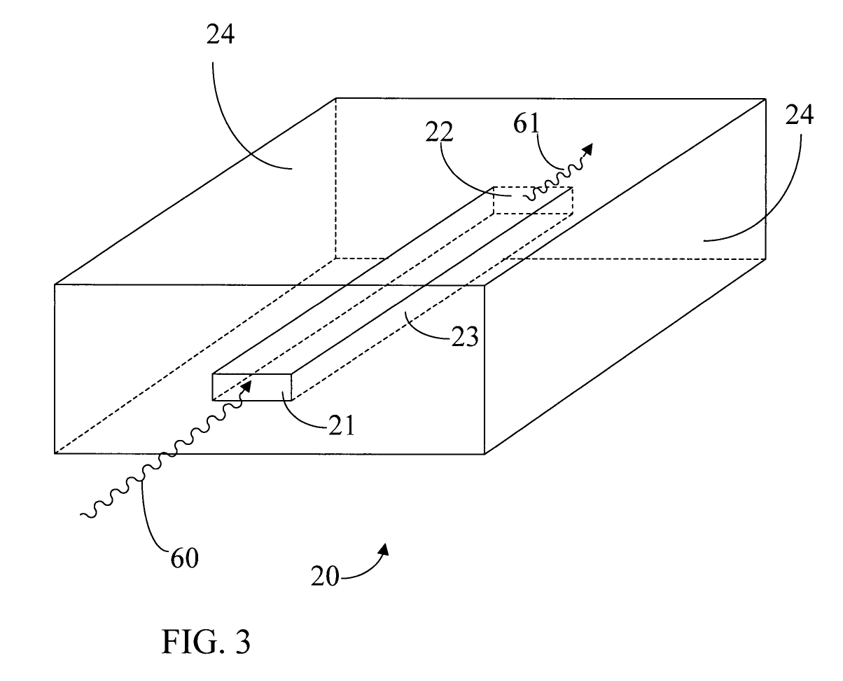

FIG. 3 shows the loss element 20. In this embodiment the loss element 20 is a waveguide composed of a core 23 heavily doped with at least one species of rare earth ion (not shown), a cladding 24, an input endface 21, and an output endface 22. The core 23 is surrounded by cladding 24 at least in part. The cladding 24 has a cladding index of refraction, which is less than the core index of refraction of the core 23. The cladding 34 may also be heavily doped with rare earth ions. The waveguide of loss element 20 is connected to receive input optical signal 60. The loss element 20 supports propagation of one or more optical modes of radiation above a certain wavelength. In an alternative embodiment, the loss element 20 is a ridge-loaded waveguide formed by disposing a lower index material having a desired width and length on top of a planar waveguide heavily doped with at least one species of rare earth ion.

Input optical signal 60 is attenuated as it propagates through the loss element 20 as it is absorbed by the un-pumped rare earth ions in the loss element 20. The attenuated optical signal 61 exits loss element 20 at the output endface 22. The attenuated optical signal 61 is shown as being shorter than the input optical signal 60 to indicate the attenuation of the input optical signal 60.

In an alternative embodiment, the loss element 20 is an un-doped waveguide, i.e., a waveguide which is not doped with a rare earth ion, although the waveguide may be doped with other elements as desired. The material or combination of materials forming the loss element 20 absorbs light at the wavelength of the input optical signal 60 while supporting propagation of one or more optical modes of radiation at that wavelength. The optical pump 51 may be coupled into the input endface 21 of loss element 20 when the un-doped waveguide of the loss element 20 is not absorbing or is minimally absorbing at the wavelength of the optical pump 51.

In another alternative embodiment, the loss element 20 is a length of absorbing material, such as a neutral density filter, which absorbs light at the wavelength of the input optical signal 60. The optical pump 51 may be coupled into the input endface 21 of the loss element 20 when the length of absorbing material of the loss element 20 is not absorbing or is minimally absorbing at the wavelength of the optical pump 51.

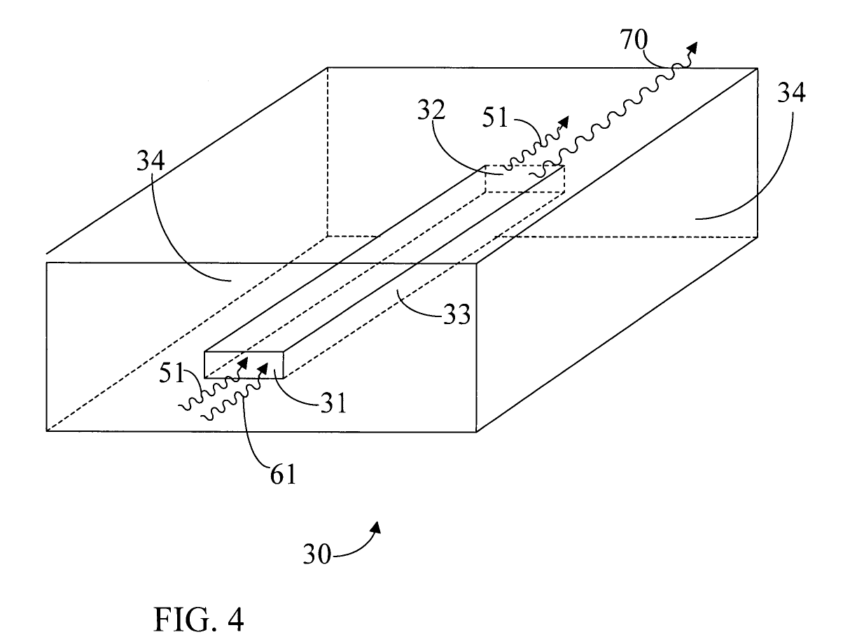

FIG. 4 shows the gain element 30. The loss element 20 and the rare earth doped gain element 30 are in optical communication, and the rare earth doped gain element 30 has a gain responsive to an optical pump 51. The gain element 30 is a waveguide composed of a core 33 heavily doped with at least one species of rare earth ion (not shown), a cladding 34, an input endface 31, and an output endface 32. The core 33 surrounds cladding 34 at least in part. The cladding 34 has a cladding index of refraction, which is less than the core index of refraction of the core 33. The cladding 34 may also be heavily doped with rare earth ions. The waveguide of gain element 30 receives an attenuated optical signal 61 and an optical pump 51. The gain element 30 supports propagation of one or more optical modes of radiation above a certain wavelength. In an alternative embodiment, the gain element 30 is a ridge-loaded waveguide formed by disposing a lower index material having a desired width and length on top of a planar waveguide heavily doped with at least one species of rare earth ion.

Attenuated optical signal 61 and the optical pump 51 are coupled to input endface 31. Attenuated optical signal 61 is amplified as a function of the intensity of optical pump 51 propagating through the gain element 30. The amplified output optical signal 70 and the optical pump 51 exit the gain element 30 at the output endface 32. Output optical signal 70 is shown as being longer than the attenuated optical signal 61, to indicate the amplification of the attenuated optical signal 61. The amplification of attenuated optical signal 61 is a result of the excitation of rare earth ions in the gain element 30 by the optical pump 51.

The loss element 20 and the gain element 30 are waveguides having respective cores 23, 33 and claddings 24, 34. The loss element 20 and the gain element 30 need not be identical, but are shown as identical in the present example for clarity. In other embodiments, the loss element 20 is an un-doped waveguide or a neutral density filter. The materials of the cladding 24, 34 need not have the same index of refraction on all sides of the cores 23, 33. The cladding index of refraction, the core index of refraction, and the geometry of the core (the width and the thickness), all affect the modal structure of light at a wavelength propagating in the waveguide. Telecommunication systems generally use single mode fibers to transmit optical signals in the wavelength region of 1.5 μm, so it is desirable that the loss element 20 and the gain element 30 forming the variable optical attenuator 10 are single mode at the wavelength of 1.5 μm for telecommunications applications. In one embodiment, the optical signal 60 to be attenuated has a wavelength in the range of 1.5 μm to 1.7 μm.

Glasses host the rare earth dopants in the core 22 and cladding 24 of the loss element 20 and core 33 and cladding 34 of the gain element 30. Glasses are covalently bonded molecules in the form of a disordered matrix with a wide range of bond lengths and bond angles. Phosphate, tellurite, and borate glasses can accept a high concentration of rare earth ions, including Er³⁺ ions. The higher solubility of rare earth ions in these glasses permits higher gain in gain element 30 and higher loss in loss element 20. Typically, the cores 23 and 33 are formed in phosphate, tellurite, or borate glasses heavily doped with rare earth ions and the claddings 24 and 34 are formed in the same type of glasses as the cores 23 and 33. When claddings 24 and 34 are not doped with rare earth dopants, the dopants in the cores 23 and 33 ensure the index of refraction of the cores 23 and 33 are higher than the index of refraction of the claddings 24 and 34.

In an alternative embodiment, phosphate, tellurite, or borate glasses heavily doped with at least one rare earth ion form the cores 23 and 33 and the claddings 24 and 34. When the cores 23 and 33 and the claddings 24 and 34 are identically doped with rare earth ions, an additional dopant is injected or diffused into the cores 22 and 32 to increase the index of refraction of the cores 23 and 33. In one embodiment, a patterned diffusion of silver ions is used to increase the index of refraction of the cores 23 and 33.

When the cores 23 and 33 and the claddings 24 and 34 are doped with different rare earth ions, the dopants are selected so the cores 23 and 33 have a higher index of refraction than the claddings 24 and 34, respectively. In this way, the core 23 can support at least one mode of input optical signal 60 and the core 33 can support at least one mode of attenuated signal 60 and optical pump 51.

The loss within the loss element 20 of the variable optical attenuator 10 results from absorption of the input optical signal 60 by the rare earth ions. In alternative embodiments, the loss element 20 is a neutral density filter or an un-doped waveguide, which absorb light at the wavelength of the input optical signal 60 and the loss results from their particular absorption characteristics.

The amplification within the gain element 30 of the variable optical attenuator 10 results from the excitation of the rare earth ions by the optical pump 51. Rare earth ions or lanthanides range from lanthanum with an atomic number of 57 to lutetium with an atomic number of 71, and are lanthanum, cerium, praseodymium, neodymium, promethium, samarium, europium, gadolinium, terbium, dysprosium, holmium, erbium, thulium, ytterbium, and lutetium.

Various rare earth doping concentrations in the cores 23 and 33 can be used in variable optical attenuator 10. In one embodiment, the cores 23 and 33 are doped with Er³⁺ in the range of 5 to 75 wt %. In another embodiment, the cores 23 and 33 are doped with Er³⁺ in the range of 5 to 30 wt %. Typically, the cores 23 and 33 are doped with Er³⁺ in the range of 7 to 9 wt %. This dopant level is high enough to produce sufficient signal loss in a short length of loss element 20 and sufficient signal gain in a short length of gain element 30.

Phosphate, tellurite, or borate glasses can accept 5 to 75 wt % of a single species of rare earth ion without precipitation. However, ion clusters may form with these high levels of dopants. Ion clusters promote ion self-interactions so that the absorbed optical pump 51 is exchanged between clustered ions and does not promote amplification of the attenuated optical signal 61. Thus, clusters deplete the pump power available for amplification as pump power is absorbed to excite ion self-interactions. Amplification is quenched if too many clusters form. In order to prevent the formation of ion clusters a second species of rare earth ion is added as a second dopant to the glass.

If the dopant level of the second species is about equal to that of the first species, the second species will decrease the probability of ion cluster formations of either species. A rare earth ion of either species is half as likely to be positioned next to a rare earth ion of the same species. The probability of large ion clusters forming is reduced even more. Thus, this mixing of different species of rare earth ions reduces ion cluster formations of either species.

In addition, the absorption cross section of the optical pump 51 in glass with more than one species of rare earth ion is larger than the absorption cross section of the optical pump 51 of either species alone. Doping a phosphate, tellurite or borate glass with two or more species of rare earth ion results in more optical pump 51 being absorbed to provide gain of attenuated optical signal 61 within the gain element 30 of variable optical attenuator 10. Doping a phosphate, tellurite or borate glass with two or more species of rare earth ion also results in a larger portion of input optical signal 60 being absorbed within the loss element 20 of variable optical attenuator 10. This improves attenuation of the input optical signal 60 in the loss element 20, and amplification of the attenuated optical signal 61 in the rare earth gain element 30 when pump power 51 is coupled to the rare earth gain element 30. This also improves attenuation of the attenuated optical signal 61 in the rare earth gain element when pump power 51 is not coupled to the rare earth gain element 30, providing greater variation in the level of the output optical signal 70.

In one embodiment, the core 23 of the loss element 20 of variable optical attenuator 10 is doped with Er³⁺ in the range of 5 to 75 wt % and Yb³⁺ in the range of 7 to 35 wt %. The core 33 of gain element 30 of variable optical attenuator 10 is doped with Er³⁺ in the range of 5 to 75 wt % and Yb³⁺ in the range of 7 to 35 wt %. In another embodiment, the core 23 of the loss element 20 of variable optical attenuator 10 is doped with Er³⁺ in the range of 5 to 30 wt % and Yb³⁺ in the range of 7 to 35 wt %. The core 33 of gain element 30 of variable optical attenuator 10 is doped with Er³⁺ in the range of 5 to 30 wt % and Yb³⁺ in the range of 7 to 35 wt %. Typically, the core 23 of the loss element 20 is doped with Er³⁺ in the range of 7 to 9 wt % and with Yb³⁺ in the range of 11 to 13 wt %, while the core 33 of gain element 30 is doped with Er³⁺ in the range of 7 to 9 wt % and with Yb³⁺ in the range of 11 to 13 wt %.

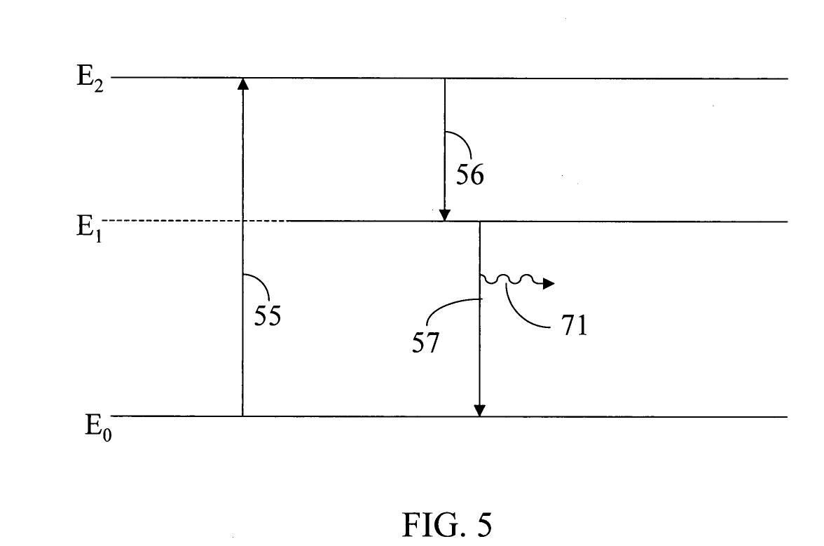

FIG. 5 shows an energy diagram of the three level system for an exemplary erbium ion Er³⁺. Ionization of the rare earth ions normally forms a trivalent state. For example, the rare earth ion erbium (Er³⁺) has a three level system with stimulated emission transitions at wavelengths of 0.80 μm, 0.98 μm, and 1.55 μm. An optical pump power at wavelength of 0.98 μm excites the erbium ion from the ground state E₀ to the energy level E₂, as illustrated by arrow 55. The ion experiences a rapid decay from energy level E₂ to the energy level E₁, as illustrated by arrow 56. The erbium ion Er³⁺ drops from the E₁ energy level to the ground state E₀, as illustrated by arrow 57, emitting a photon 71 having a wavelength of about 1.55 μm. The emitted photon 71 has a probability of being emitted within a range of wavelengths centered about the wavelength region of 1.55 μm due to the fine structure of the ion energy levels (not shown).

The higher the level of doping of the rare earth ions in the loss element and the gain element, the higher the attenuation and amplification levels in the loss element and the gain element, respectively. The higher the attenuation and amplification levels, the shorter the variable optical attenuator needs to be for a desired range of optical attenuation. The attenuated signal at a wavelength within the gain spectrum of an exemplary rare earth ion may be designed to propagate with an optical pump power in the gain element 30. When the optical pump 51 is at the wavelength needed to excite the rare earth ions, the attenuated optical signal 61 will be amplified after propagating a short distance by the photons 72. The photons 72 are emitted by a stimulated process as the excited rare earth ions drop into the ground state E₀.

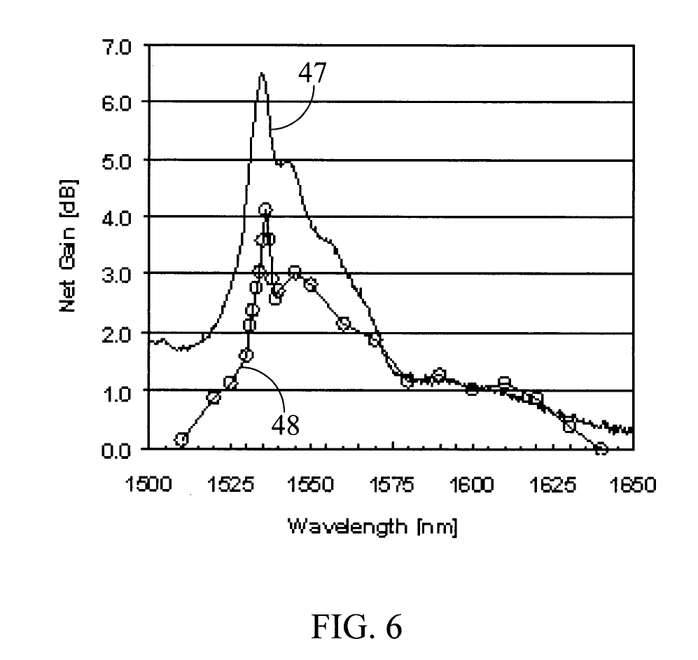

FIG. 6 shows the theoretical gain spectrum 75 of a gain element formed from phosphate glass heavily doped with erbium and ytterbium. In this embodiment, the dopant level is about 8 wt % Er³⁺ and about 12 wt % Yb³⁺. Such glass is available from Schott Corporation (number IOG-1). FIG. 6 also shows the measured gain spectrum 76 for an actual gain element. The core of the gain element was formed in the 8 wt % Er³⁺ and 12 wt % Yb³⁺ doped phosphate glass by diffusion of silver ions. The core dimensions were 13 μm wide and 5 μm thick. Air formed the top cladding layer for the core and the phosphate glass substrate formed the bottom and side cladding. A 3 mm length of the gain element amplified an input signal at 1.534 μm by 4 dB using when an input optical pump power of less than 180 mW at 974 nm was coupled to the gain element. In another embodiment, an encapsulating top cladding layer is applied to reduce the scattering loss and to increase the overall transmission of the gain element.

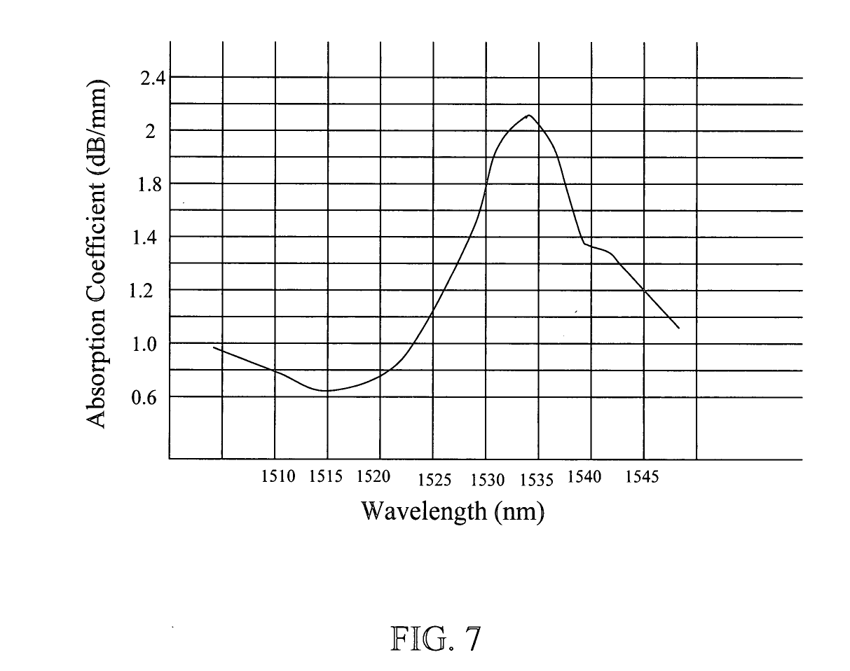

FIG. 7 shows the absorption coefficient in dB/mm for phosphate glass doped with 8 wt % Er³⁺ and 12 wt % Yb³⁺. The peak absorption is more than 2.0 dB per mm at the wavelength of 1.534 μm. For a loss element similar to the gain element described above in conjunction with FIG. 6, the loss will be about 2 dB per mm for a signal at a wavelength of 1.534 μm. The loss would be similar in gain element 30 without the optical pump 51 applied.

When the loss element 20 is a neutral density filter or an un-doped waveguide, the filter or waveguide material is chosen for its absorption spectral characteristics. The loss of the input optical signal 60 through the loss element 20 is a function of the propagation length-absorption coefficient product at the wavelength of the input optical signal 60. The propagation length-absorption coefficient product is used to design the loss element 20 so that the loss is offset to a varying degree by the gain as optical pump 51 illuminates the gain element 30 with varying intensities.

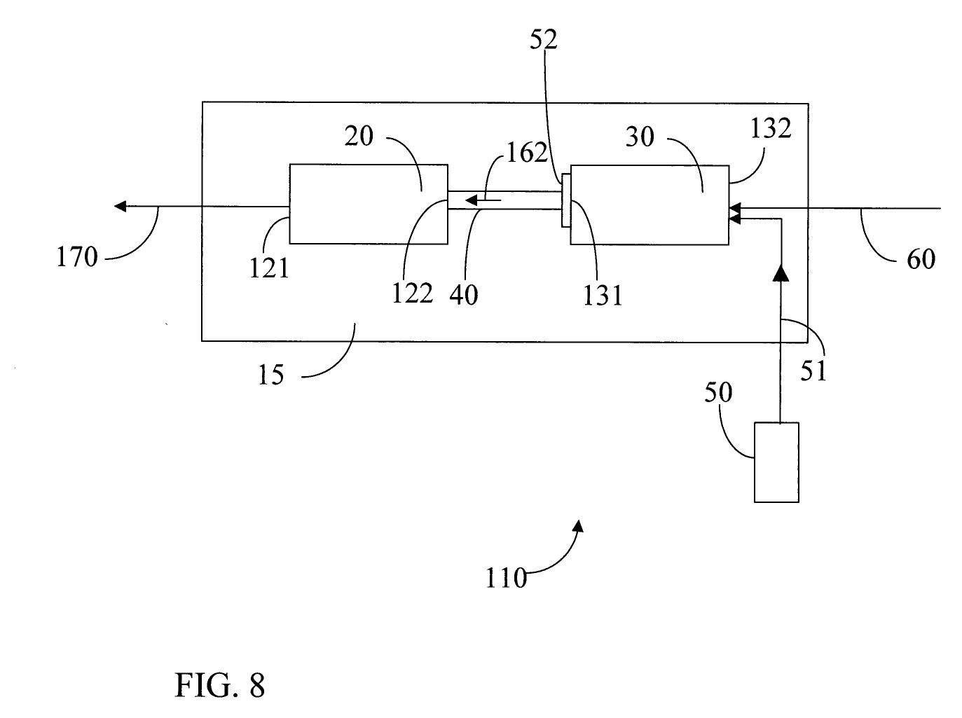

FIG. 8, in which like elements share like reference numbers with FIG. 1, shows a top view of an alternative embodiment of variable optical attenuator 110 in which the input optical signal 60 is coupled to the gain element 30 instead of the loss element 20. The embodiment of FIG. 8 is similar to the embodiment of FIG. 1, except that the input faces and output faces are reversed. A filter 52 is placed between to the output endface 131 and coupling element 40 to absorb or reflect optical pump 51. In an alternative embodiment, no filter is necessary when the loss element 20 is a neutral density filter or an un-doped waveguide, which absorbs light at the wavelength of the input optical signal 60.

The input optical signal 60 couples to input endface 132 of the gain element 30 and exits output endface 131. The gain element 30 amplifies input optical signal 60, which exits the output endface 131 as intermediate signal 162. The amplification depends on the intensity of optical pump 51 illuminating the gain element 30 at input endface 132. The intensity of optical pump 51 illuminating the gain element 30 is varied by changing the intensity of optical pump 51 emitted from the optical pump source 50 or by changing the coupling between the optical source 50 and the gain element 30. If no optical pump 51 is coupled to the gain element 30, the input optical signal 60 is attenuated when passing through the gain element 30.

Intermediate signal 162 passes through the filter 52 and couples to the coupling element 40. The filter 52 absorbs or reflects optical pump 51, so that optical pump 51 is not input into the loss element 20 and the loss element 20 will not act as a gain element 30. The coupling element 40 transmits the intermediate signal 162 to input endface 122, where the intermediate signal 162 couples to the loss element 20. The intermediate signal 162 is attenuated by the loss element 20 and exits output endface 121 as output optical signal 170.

The intensity of output optical signal 170 varies between 0 dB and more than −60 dB with respect to the input optical power 60, depending on the design of the variable optical attenuator and the intensity of the optical pump 51 illuminating the gain element 30. In an alternate embodiment of variable optical attenuator 110, the filter 52 is placed between the coupling element 40 and the input endface 122 of loss element 20.

In an alternative embodiment, the optical pump 51 illuminates the gain element 30 at the input endface 131 and no filter is used in the variable optical attenuator 110. The optical pump 51 counter-propagates with the optical signal 60 within the gain element 30.

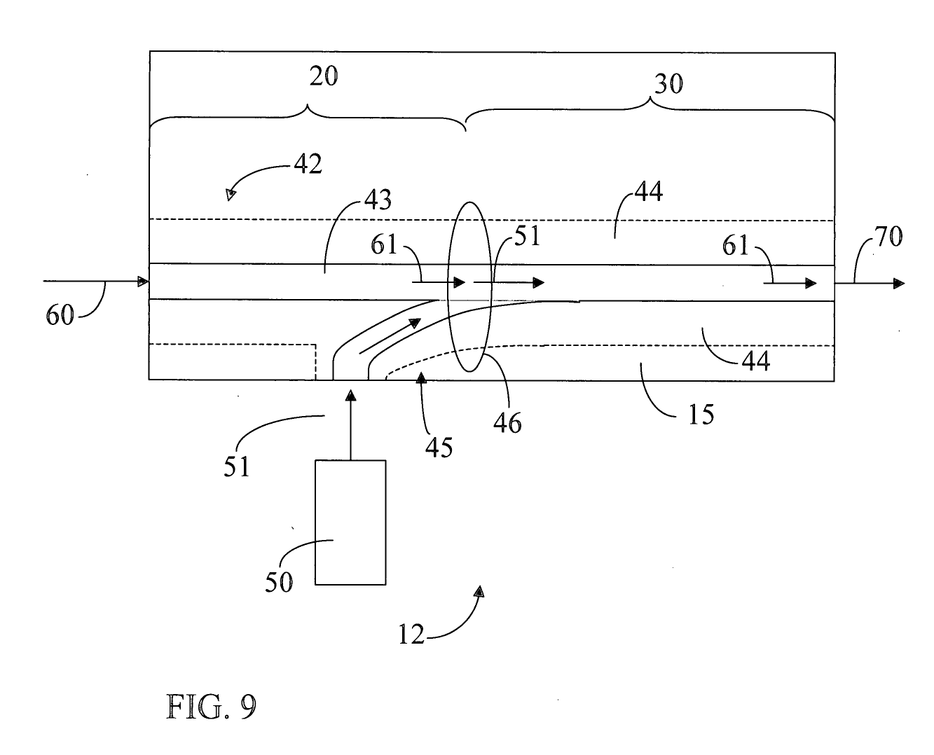

FIG. 9, in which like elements share like reference numbers with FIG. 1, shows a variable optical attenuator 12 in which the gain element 30 and the loss element 20 share a common waveguide 42. The core 43 of waveguide 42 is heavily doped with rare earth ions and is surrounded by cladding 44 at least in part. The common waveguide 42 of variable optical attenuator 12 obviates the need for coupling element 40 of variable optical attenuator 10 as shown in FIG. 1. The variable optical attenuator 12 is a rare earth doped waveguide 42 connected to receive the optical pump 51 at a coupling region 46, which is located at an intermediate portion along the waveguide 42. The optical pump 51 is coupled to waveguide 42 in a coupling region 46 formed by a Y-branch 45 of waveguide 42 intersecting the waveguide core 42. The gain element 30 begins at the coupling region 46 where the optical pump 51 enters the single core 43. The intensity of optical pump 51 illuminating the gain element 30 is controlled by changing the intensity of optical pump 51 emitted by the optical pump source 50 or by changing the coupling between the optical pump source 50 and the gain element 30. The waveguide 42 and the branch waveguide 45 are supported by substrate 15.

In one embodiment, the optical pump source 50 couples to a common waveguide 42 via the branch waveguide 45 at the midpoint of the waveguide 42. This ensures that the gain within the gain element 30 and the absolute value of loss in the loss element 20 are equal. In alternative embodiments, the optical pump 51 can be coupled to the coupling region of waveguide 42 with diffractive couplers, directional couplers, grating couplers, and combinations thereof.

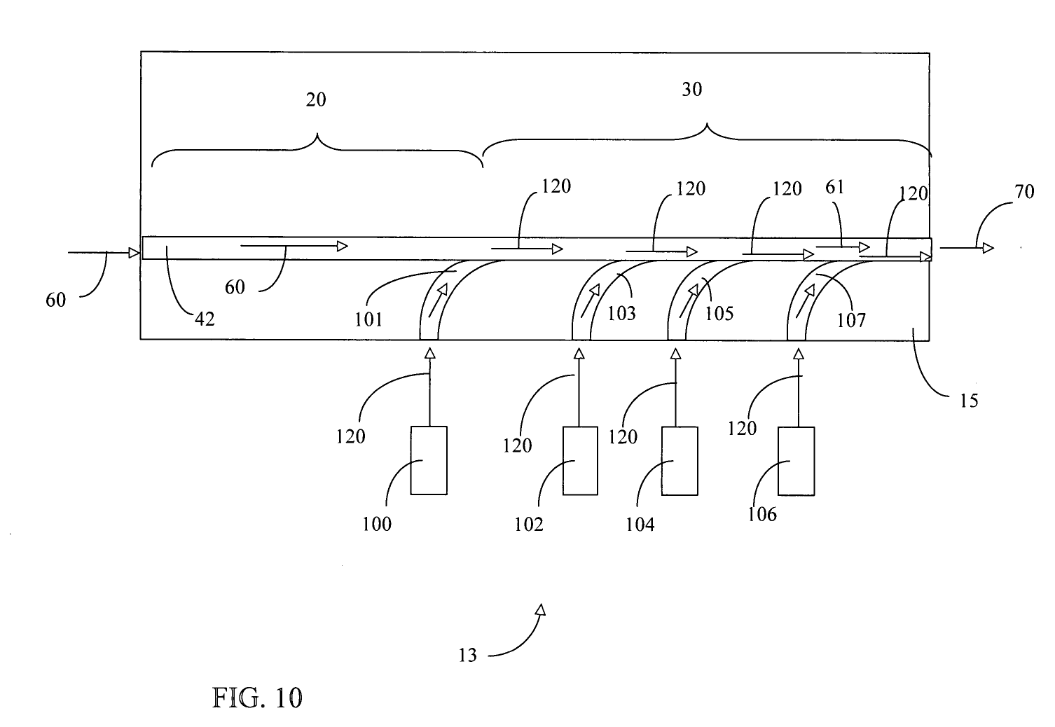

FIG. 10 shows a variable optical attenuator 13 in which the gain element 30 and the loss element 20 share a common waveguide 42 with a core (not shown) heavily doped with rare earth ions and surrounded by a cladding (not shown) on at least one side. Optical pump power 120 is coupled to the waveguide 42 at several coupling regions formed by Y-branch waveguides 101, 103, 105, and 107 which intersect the waveguide 42. The optical pump sources 100, 102, 104, and 106 are aligned with and coupled to the Y-branch waveguides 101, 103, 105, and 107, respectively. The waveguide 42, the optical pump sources 100, 102, 104, and 106 and the branch waveguides 101, 103, 105, and 107 are supported by substrate 15. In one embodiment, the optical pump source 100 couples to single waveguide 42 at the midsection of the waveguide 42.

The intensity of the output optical signal 70 from variable optical attenuator 13 is controlled by turning on different numbers of the pump sources 100, 102, 104, and 106. The pump sources can be the same or can each provide a different optical pump power. If none of the pump sources 100, 102, 104, and 106 are on, the input optical signal 60 is attenuated to a low intensity.

In one embodiment, the optical pump power 120 coupled to the gain element 30 is varied by changing the coupling of the pump sources 100, 102, 104, and 106 into branch waveguides 101, 103, 105, and 107, respectively. The coupling is changed by moving the pump sources 100, 102, 104, and 106 with respect to the branch waveguides 101, 103, 105, and 107, respectively, or by moving the coupling mechanism between a pump source and branch waveguide. In another embodiment, the optical pump power 120 illuminating the gain element 30 is varied by changing the intensity of the light emitted by the pump sources 100, 102, 104, and 106. In yet another embodiment, the optical pump power 120 illuminating the gain element 30 is varied by changing the intensity of the light emitted by the pump sources 100, 102, 104, and 106 and changing the coupling of the pump sources 100, 102, 104, and 106 into branch waveguides 101, 103, 105, and 107, respectively.

The functional boundary between the gain element 30 and the loss element 20 moves as the different pump sources provide optical pump power to the waveguide. The gain element 30 begins at the first coupling region where the optical pump power 120 enters the single waveguide 42. When the pump source 100 is on, the gain element begins at Y-branch waveguide 101. When the pump sources 100 and 102 are off and pump source 104 is on, the gain element 30 begins where the Y-branch waveguide 105 intersects with the waveguide 42.

While the embodiments of the invention disclosed herein are presently considered to be preferred, various changes and modifications can be made without departing from the scope of the invention. The scope of the invention is indicated in the appended claims, and all changes that come within the meaning and range of equivalents are intended to be embraced therein.

1. A variable optical attenuator, comprising:
a loss element; and
a rare earth doped gain element in optical communication with the loss element, the rare earth doped gain element having a gain responsive to an optical pump.

2. The variable optical attenuator of claim 1, in which the loss element comprises one of a rare earth doped waveguide, an un-doped waveguide, and a neutral density filter.

3. The variable optical attenuator of claim 1, in which the loss element is doped with Er³⁺ in the range of 5 to 30 wt %.

4. The variable optical attenuator of claim 3, in which the loss element is additionally doped with Yb³⁺ in the range of 7 to 35 wt %.

5. The variable optical attenuator of claim 1, in which the rare earth doped gain element is doped with Er³⁺ in the range of 5 to 30 wt %.

6. The variable optical attenuator of claim 5, in which the rare earth doped gain element is additionally doped with Yb³⁺ in the range of 7 to 35 wt %.

7. The variable optical attenuator of claim 1, additionally comprising:
a waveguide including a core and a cladding, the cladding at least partially surrounding the core, in which the core is doped with at least one species of rare earth ion in the range of 5 to 75 wt %; and
a coupling region in optical communication with the waveguide, the coupling region connected to receive an optical pump and provide the optical pump to at least a portion of the waveguide;
in which the waveguide includes the loss element and the rare earth doped gain element.

8. The variable optical attenuator of claim 7, in which the core is doped with Er³⁺ in the range of 5 to 30 wt %.

9. The variable optical attenuator of claim 8, in which the core is additionally doped with Yb³⁺ in the range of 7 to 35 wt %.

10. The variable optical attenuator of claim 7, in which the cladding is doped with Er³⁺ in the range of 5 to 30 wt %.

11. The variable optical attenuator of claim 10, in which the cladding is additionally doped with Yb³⁺ in the range of 7 to 35 wt %.

12. The variable optical attenuator of claim 7, in which the core includes silver atoms.

13. The variable optical attenuator of claim 7, in which the coupling region is located at an intermediate portion along the waveguide.

14. The variable optical attenuator of claim 7, in which the coupling region of the optical pump comprises one of a diffractive coupler, a y-branch coupler, a directional coupler, a grating coupler, a fused optical fiber coupler, and a combination thereof.

15. The variable optical attenuator of claim 7, in which the coupling region comprises coupling regions connected to receive respective optical pumps.

16. A method of varying optical attenuation, comprising:
optically connecting a loss element in series with a rare earth doped gain element;
passing an optical signal through the loss element and the gain element;
attenuating the optical signal in the loss element; and
illuminating the gain element with optical pump power having an intensity that defines the attenuation.

17. The method of claim 16, in which the illuminating comprises:
co-propagating the optical signal and the optical pump power within the rare earth gain element.

18. The method of claim 16, in which the passing comprises:
coupling the optical signal to the loss element;
coupling the optical signal from the loss element to the rare earth gain element.

19. The method of claim 16, in which the passing comprises:
coupling the optical signal to the rare earth gain element;
coupling the optical signal from the rare earth gain element to the loss element.

20. The method of claim 19, additionally comprising:
filtering pump power between the loss element and the rare earth gain element.
